(19) United States
(12) Patent Application Publication
(10) Pub. No.: US 2026/0280680 A1
(43) Pub. Date: Sep. 17, 2026

(54) METHODS AND APPARATUS FOR BEAM MANAGEMENT IN MOBILE COMMUNICATIONS

(71) Applicant: MEDIATEK INC., Hsinchu City (TW)

(72) Inventors: Yi-Ru CHEN, Hsinchu City (TW); Cheng-Rung TSAI, Hsinchu City (TW)

(73) Assignee: MEDIATEK INC., Hsinchu City (TW)

(21) Appl. No.: 19/472,788

(22) PCT Filed: Aug. 2, 2024
(86) PCT No.: PCT/CN2024/109416

§ 371 Date: Oct. 6, 2025

Related U.S. Application Data
(60) Provisional application No. 63/517,621, filed on Aug. 4, 2023.

(51) Int. Cl. H04B 7/06; H04W 24/10

(52) U.S. Cl. CPC H04B 7/06968; H04W 24/10

(57) ABSTRACT

Various solutions for beam management with respect to user equipment and network node in mobile communications are described. An apparatus may receive at least one reference signal from a network node. The apparatus may transmit a beam report to the network node. The beam report may indicate at least one beam which has been synchronized by the apparatus.

### CROSS REFERENCE TO RELATED PATENT APPLICATION(S)

The present disclosure is part of a non-provisional application claiming the priority benefit of U.S. Patent Application No. 63/517,621, filed 4 Aug. 2023, the content of which herein being incorporated by reference in its entirety.

### TECHNICAL FIELD

The present disclosure is generally related to mobile communications and, more particularly, to beam management with respect to user equipment (UE) and network apparatus in mobile communications.

### BACKGROUND

Unless otherwise indicated herein, approaches described in this section are not prior art to the claims listed below and are not admitted as prior art by inclusion in this section.

In conventional beam management procedure, the network node may transmit at least one downlink (DL) reference signal (RS) to the UE. Then, the UE may perform a measurement according to the DL RS to generate a beam report. After the UE transmits the beam report to the network node, the network node may need to perform a beam activation procedure to determine the beams. Then, the UE may need to perform the extra measurement according to further reference signals for the beams indicated in the beam activation command from the network node to complete the synchronization for the beams. After the measurement for the beams has been performed, the network node may transmit a beam indication for beam switching to the UE. Therefore, the over beam switching latency in the current beam management procedure would be very long and inefficient.

Accordingly, how to reduce the latency in the beam management procedure becomes an important issue for the newly developed wireless communication network. Therefore, there is a need to provide proper schemes to shorten the overall beam switching latency and improve the beam management procedure.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods and apparatus pertaining to beam management with respect to user equipment and network apparatus in mobile communications. It is believed that the above-described issue would be avoided or otherwise alleviated by implementing one or more of the proposed schemes described herein.

In one aspect, a method may involve an apparatus receiving at least one reference signal from a network node. The method may also involve the apparatus transmitting a beam report to the network node, wherein the beam report may indicate at least one beam which has been synchronized by the apparatus.

In another aspect, an apparatus may involve a transceiver which, during operation, wirelessly communicates with at least one network node. The apparatus may also involve a processor communicatively coupled to the transceiver such that, during operation, the processor may receive, via the transceiver, at least one reference signal from the network node. The processor may also transmit, via the transceiver, a beam report to the network node, wherein the beam report may indicate at least one beam which has been synchronized by the apparatus.

In another aspect, a method may involve a network node transmitting at least one reference signal to a user equipment (UE). The method may also involve the network node receiving a beam report from the UE, wherein the beam report may indicate at least one beam which has been synchronized by the UE.

It is noteworthy that, although description provided herein may be in the context of certain radio access technologies, networks and network topologies such as 5th Generation System (5GS) and 4G EPS mobile networking, the proposed concepts, schemes and any variation(s)/derivative(s) thereof may be implemented in, for and by other types of wireless and wired communication technologies, networks and network topologies such as, for example and without limitation, Ethernet, Universal Terrestrial Radio Access Network (UTRAN), E-UTRAN, Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, IoT, Industrial IoT (IIoT), Narrow Band Internet of Things (NB-IoT), 6th Generation (6G), and any future-developed networking technologies. Thus, the scope of the present disclosure is not limited to the examples

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example scenario for a beam management procedure under the first proposed scheme in accordance with implementations of the present disclosure.

FIG. 3 is a diagram depicting an example scenario for a beam management procedure under the second proposed scheme in accordance with implementations of the present disclosure.

FIG. 4 is a diagram depicting an example scenario for a beam management procedure without beam activation in accordance with implementations of the present disclosure.

FIG. 5 is a block diagram of an example communication system in accordance with an implementation of the present disclosure.

FIG. 6 is a flowchart of an example process in accordance with an implementation of the present disclosure.

FIG. 7 is a flowchart of an example process in accordance with another implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to beam management with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

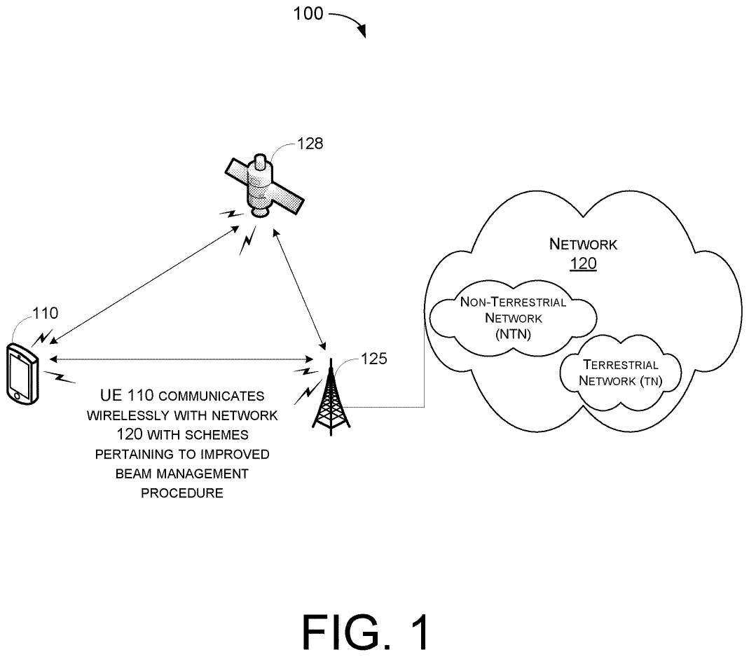

FIG. 1 illustrates an example scenario 100 of a communication environment in which various solutions and schemes in accordance with the present disclosure may be implemented. Scenario 100 involves a UE 110 in wireless communication with a network 120 (e.g., a wireless network including an NTN and a TN) via a terrestrial network node 125 (e.g., an evolved Node-B (eNB), a Next Generation Node-B (gNB), or a transmission/reception point (TRP)) and/or a non-terrestrial network node 128 (e.g., a satellite). For example, the terrestrial network node 125 and/or the non-terrestrial network node 128 may form a non-terrestrial network (NTN) serving cell for wireless communication with the UE 110. In some implementations, the UE 110 may be an IoT device such as an NB-IoT UE or an enhanced machine-type communication (eMTC) UE (e.g., a bandwidth reduced low complexity (BL) UE or a coverage enhancement (CE) UE). In such communication environment, the UE 110, the network 120, the terrestrial network node 125, and the non-terrestrial network node 128 may implement various schemes pertaining to beam management in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

According to the implementations of the present disclosure, a UE (e.g., the UE 110) may receive at least one reference signal (e.g., downlink (DL) reference signal (RS)) from a network node (e.g., the terrestrial network node 125).

Then, the UE may perform a synchronization for at least one beam according to the reference signal before transmitting a beam report to the network node. Specifically, the UE may perform a measurement according to the reference signal (or reference signals) from the network node to select the beam (or beams) with better signal quality (e.g., the reference signal received power (RSRP) of the beam is larger than a threshold). Then, the UE may perform a time and frequency tracking based on the synchronization signal block (SSB) (or SSBs) for the beam (or beams) to synchronize the selected beam (or beams) before transmitting a beam report to the network node. That is, the UE can pre-synchronize the beam (or beams) before a network (NW)-initiated beam activation or a NW-initiated beam indication to reduce the latency during the beam management procedure.

After the synchronization for at least one beam, the UE may transmit a beam report to the network node. The beam report may indicate the beam (or beams) which has (or have) been synchronized by the apparatus. In an example, all beams indicated in the beam report have been synchronized by the apparatus. In another example, the beam report may comprise an indicator. The indicator may indicate the beam (or beams) which has (or have) been synchronized by the apparatus and indicate the beam (or beams) which has (or have) not been synchronized by the apparatus.

The beam report may comprise at least one RS index (or RS identification (ID)) or at least one transmission configuration indicator (TCI) state index (or TCI state ID) associated with the beam (or beams). That is, the UE may report (or indicate) a beam by its associated RS index or TCI-state index in the beam report. Each RS index may be associated with a different TCI state index. In an example, when an RS or a TCI state reported in the beam report is indicated as “synchronized”, it means that the UE has performed synchronization for the beam associated with the TCI-state or the RS. In another example, when an RS or a TCI state reported in the beam report is indicated as “unsynchronized”, it means that the UE has not performed synchronization for the beam associated with the TCI-state or the RS.

In an example, the association between an RS corresponding to the RS index and a TCI state corresponding to the TCI state index may be determined according to a quasi-co-location (QCL) type or a radio resource control (RRC) configuration. Specifically, the UE may determine the association between the RS index and the TCI state index according to the source RS for QCL-TypeD, or the RRC configuration from the network node.

Under a first proposed scheme for the beam management procedure in accordance with the present disclosure, after the UE transmits the beam report to the network node, the UE may receive a beam indication for a beam switching through downlink control information (DCI) from the network node. That is, in the first proposed scheme, the network node may not need to perform the beam activation procedure. The beam indication may indicate at least one serving TCI state. Specifically, the network node may select the beam (or beams) for beam switching from the beam (or beams) in the beam report, and transmit the serving TCI state (or serving TCI states) associated with the selected beam (or beams) through the beam indication to the UE.

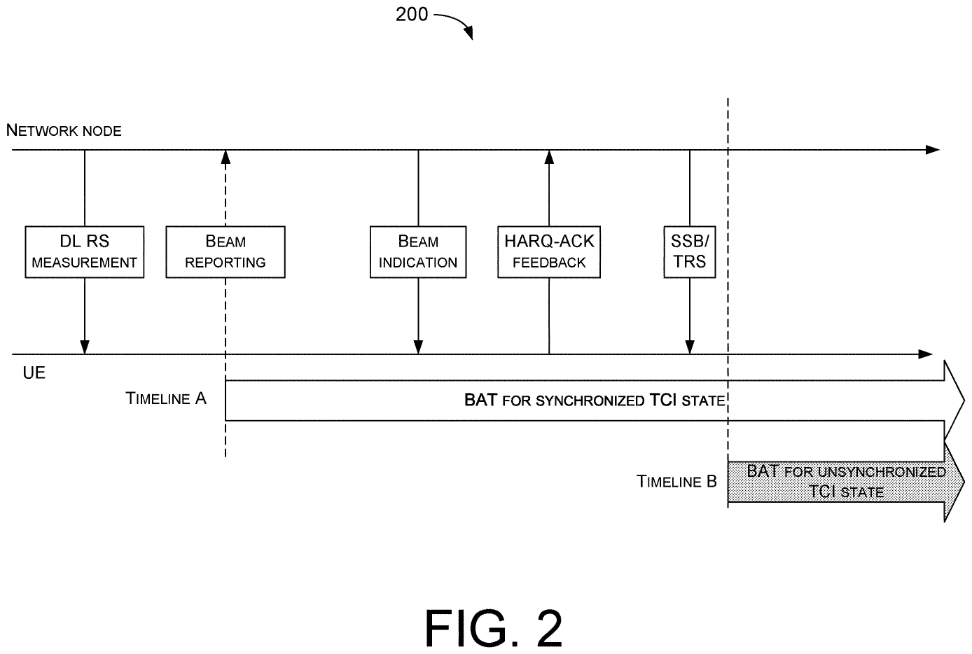

In an example, when the serving TCI state is associated with a beam which has been synchronized by the UE, a beam applicable time (BAT) for the beam may be started after the beam report is reported (or sent) (e.g., the BAT as shown in timeline A of FIG. 2). That is, the beam which has been synchronized by the UE is applicable for DL reception after the beam report is sent. In other words, the beam has been prepared for transmission/reception (e.g., perform data channel transmission/reception or control channel transmission/reception) after the beam report is reported (or sent). Therefore, after the UE receives the serving TCI state indicated in the beam indication for a beam switching, the UE may directly switch to the beam associated with the serving TCI state for transmission/reception.

In another example, when the serving TCI state is associated with a beam which has not been synchronized by the UE, the BAT for the beam may be started after another reference signal is received from the network node (e.g., the BAT as shown in timeline B of FIG. 2). That is, the beam which has been not synchronized by the UE may be applicable for DL reception after the reception of another reference signal associated with the beam. In other words, the UE may need to perform synchronization for the beam which has not been synchronized by the UE according to the reference signal associated with the serving TCI state. For example, the UE may receive the SSB or tracking reference signal (TRS) associated with the serving TCI state from the network node, and perform measurement (i.e., time and frequency tracking) on the SSB or TRS to synchronize the beam. After the UE has performed synchronization for the beam, the UE may switch to the beam associated with the serving TCI state for transmission/reception. In the example, when the network node determine to select the serving TCI state associated with the beam which has not been synchronized by the UE, the network node may trigger the SSB or TRS reception associated with the serving TCI state in the beam indication for beam switching through the same DCI. Therefore, the network node can bring forward the timing of the SSB or TRS.

FIG. 2 illustrates an example scenario 200 for a beam management procedure under the first proposed scheme in accordance with implementations of the present disclosure. Scenario 200 involves a UE and a network node (e.g., a (macro/micro) base station) of a wireless network (e.g., an LTE network, a 5G/NR network, an IoT network or a 6G network). Referring to FIG. 2, the network node may transmit the DL RS for measurement to the UE. Then, the UE may perform the measurement according to the DL RS and perform a synchronization for at least one beam before transmitting a beam report to the network node. After the UE transmit the beam report to the network node, the UE may receive a beam indication for beam switching through a DCI from the network node, and transmit a hybrid automatic repeat request (HARQ)-acknowledgement (ACK) feedback for the beam indication to the network node. The beam indication may indicate at least one serving TCI state. If the serving TCI state is associated with a beam which has been synchronized by the UE, the UE may directly switch to the beam associated with the serving TCI state to transmit data. If the serving TCI state is associated with a beam which has not been synchronized by the UE, the UE may further receive the SSB or TRS associated with the beam to synchronize the beam, and then switch to the beam associated with the serving TCI state for transmission/reception.

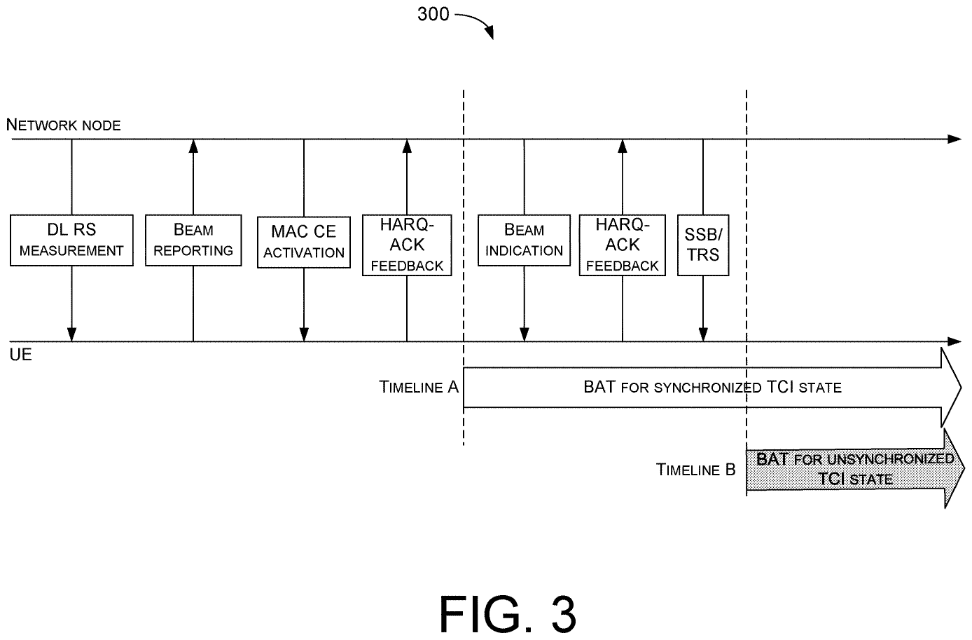

Under a second proposed scheme for the beam management procedure in accordance with the present disclosure, after the UE transmits the beam report to the network node, the UE may receive a beam activation command (e.g., medium access control (MAC) control element (MAC CE) activation command) from the network node. The beam activation command may indicate at least one beam which is selected (or activated) by the network node according to the beam report. The beam selected by the network node may be the same or different from the beam reported in the beam report. The network node may activate the TCI state associated with the selected beam through the beam activation command. If a synchronized TCI state (i.e., the beam associated with the TCI state has been synchronized by the UE) is activated, the BAT of the activated TCI state is started after the beam activation command is received from the network node (e.g., the BAT as shown in timeline A of FIG. 3). That is, in an event that the beam indicated in the beam activation command is the beam in the beam report which has been synchronized by the UE, the beam indicated in the beam activation command is applicable for DL reception after the beam activation command is applied. If an unsynchronized TCI state (i.e., the beam associated with the TCI state has not been synchronized by the UE) is activated, the BAT of the activated TCI state may be started after another reference signal is received from the network node (e.g., the BAT as shown in timeline B of FIG. 3). That is, in an event that the beam indicated in the beam activation command is the beam in the beam report which has been not synchronized by the UE, the beam is applicable for downlink reception after reception of a reference signal associated with the beam indicated in the beam activation command.

After the UE applies (or receives) the beam activation command form the network, the UE may receive a beam indication for a beam switching through a DCI from the network node. The beam indication may indicate at least one serving TCI state. Specifically, the network node may select the serving TCI state (or serving TCI states) from the activated the TCI state (or activated the TCI states) in the beam activation command. Then, the network node may transmit the serving TCI state (or serving TCI states) associated with the selected beam (or beams) through the beam indication to the UE.

In an example, when the serving TCI state is associated with a beam which has been synchronized by the UE, the BAT for the beam may be started after the beam activation command is received from the network node (e.g., the BAT as shown in timeline A of FIG. 3). That is, in an event that the beam indicated in the beam activation command is the beam in the beam report which has been synchronized by the UE, the beam indicated in the beam activation command is applicable for DL reception after the beam activation command is applied. In other words, the beam has been prepared for transmission/reception (e.g., perform data channel transmission/reception or control channel transmission/reception) after the beam activation command is received from the network node. Therefore, after the UE receives the serving TCI state indicated in the beam indication for a beam switching, the UE may directly switch to the beam associated with the serving TCI state for transmission/reception.

In another example, when the serving TCI state is associated with a beam which has not been synchronized by the UE, the BAT for the beam may be started after another reference signal is received from the network node (e.g., the BAT as shown in timeline B of FIG. 3). That is, in an event that the beam indicated in the beam activation command is the beam in the beam report which has been not synchronized by the UE, the beam is applicable for downlink reception after reception of a reference signal associated with the beam indicated in the beam activation command. In other words, the UE may need to perform synchronization for the beam which has not been synchronized by the UE according to the reference signal associated with the serving TCI state. For example, the UE may receive the SSB or TRS associated with the serving TCI state from the network node, and perform measurement (i.e., time and frequency tracking) on the SSB or TRS to synchronize the beam. After the UE has performed synchronization for the beam, the UE may switch to the beam associated with the serving TCI state for transmission/reception.

In the second proposed scheme, when there is only one activated TCI state in the beam activation command, i.e., the activated TCI state TCI state is the serving TCI state, the beam activation command can be regarded as beam indication.

FIG. 3 illustrates an example scenario 300 for a beam management procedure under the second proposed scheme in accordance with implementations of the present disclosure. Scenario 300 involves a UE and a network node (e.g., a (macro/micro) base station) of a wireless network (e.g., an LTE network, a 5G/NR network, an IoT network or a 6G network). Referring to FIG. 3, the network node may transmit the DL RS for management to the UE. Then, the UE may perform the measurement according to the DL RS and perform a synchronization for at least one beam before transmitting a beam report to the network node. After the UE transmit the beam report to the network node, the UE may receive a beam activation command from the network node, and transmit a HARQ-ACK feedback for the beam activation command to the network node. Then, the UE may receive a beam indication for beam switching through a DCI from the network node, and transmit a HARQ-ACK feedback for the beam indication to the network node. The beam indication may indicate at least one serving TCI state based on the beam activation command. If the serving TCI state is associated with a beam which has been synchronized by the UE, the UE may directly switch to the beam associated with the serving TCI state to transmit data. If the serving TCI state is associated with a beam which has not been synchronized by the UE, the UE may further receive the SSB or TRS associated with the beam to synchronize the beam, and then switch to the beam associated with the serving TCI state to transmit data.

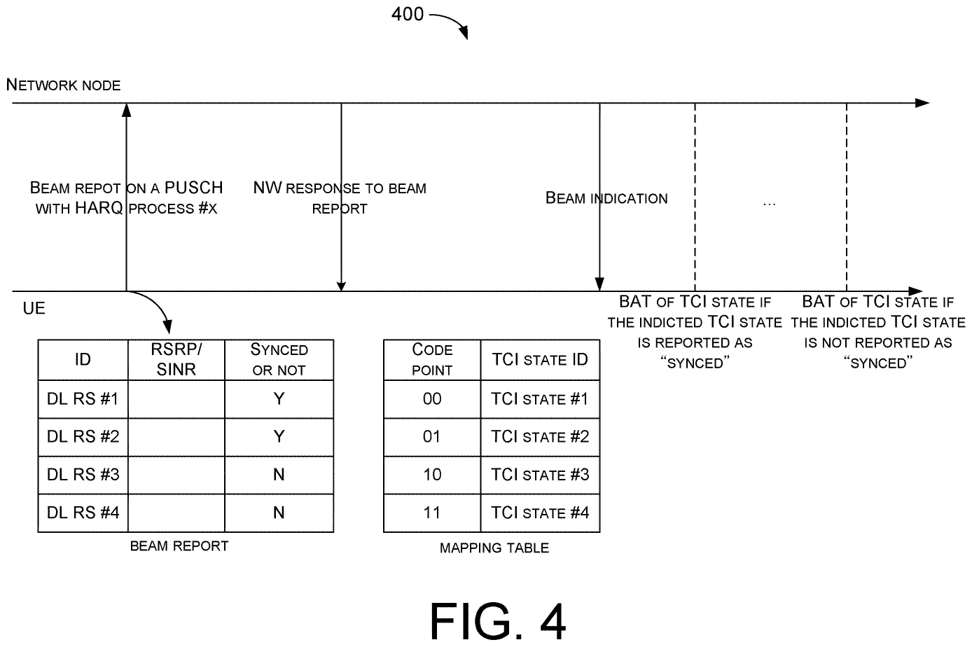

FIG. 4 illustrates an example scenario 400 for a beam management procedure without beam activation (i.e., first proposed scheme) in accordance with implementations of the present disclosure. Scenario 400 involves a UE and a network node (e.g., a (macro/micro) base station) of a serving cell which may be a part of a wireless network (e.g., an LTE network, a 5G/NR network, an IoT network or a 6G network). Referring to FIG. 4, the UE may transmit a beam report to the network node on a physical uplink shared channel (PUSCH) with HARQ process #x. The beam report may indicate the DL RS ID (i.e., DL RS #1~DL RS #4) associated with the beams selected by the UE. In addition, the beam report may indicate that the beams associated with the DL RS #1~DL RS #2 have been synchronized by the UE, and the beams associated with the DL RS #3~DL RS #4 have not been synchronized by the UE. After the network node receives the beam report, the network node may transmit a response (i.e., NW response) and a beam indication to the UE according to the beam report. The response (e.g., an ACK message) may indicate that the network node has confirmed that the beams in beam report can be used to correspond to the TCI field codepoint. Therefore, the UE may establish the mapping table between the TCI states (e.g., TCI state #1, TCI state #2, TCI state #3, and TCI state #4) and TCI field codepoint (e.g., 00, 01, 10, 11) according to the response. That is, the UE may refer to the association between the DL RS IDs and the TCI state IDs which is determined according to the source RS for QCL-TypeD or the RRC configuration (e.g., DL RS ID #1 is associated with TCI state #1, DL RS ID #2 is associated with TCI state #2, DL RS ID #3 is associated with TCI state #3, and DL RS ID #4 is associated with TCI state #4) to establish the mapping table according to the order of the DL RSs in the beam report. For example, a PDCCH reception with a DCI may schedule a physical uplink shared channel (PUSCH) transmission with the same HARQ process number as for the transmission of the PUSCH with beam report and have a toggled new data indicator (NDI) field value. The response may be transmitted with the beam indication through the same DCI. In the example, the BAT of the indicted TCI state being reported as “synced” is prior to the BAT of the indicted TCI state being not reported as “synced”.

### Illustrative Implementations

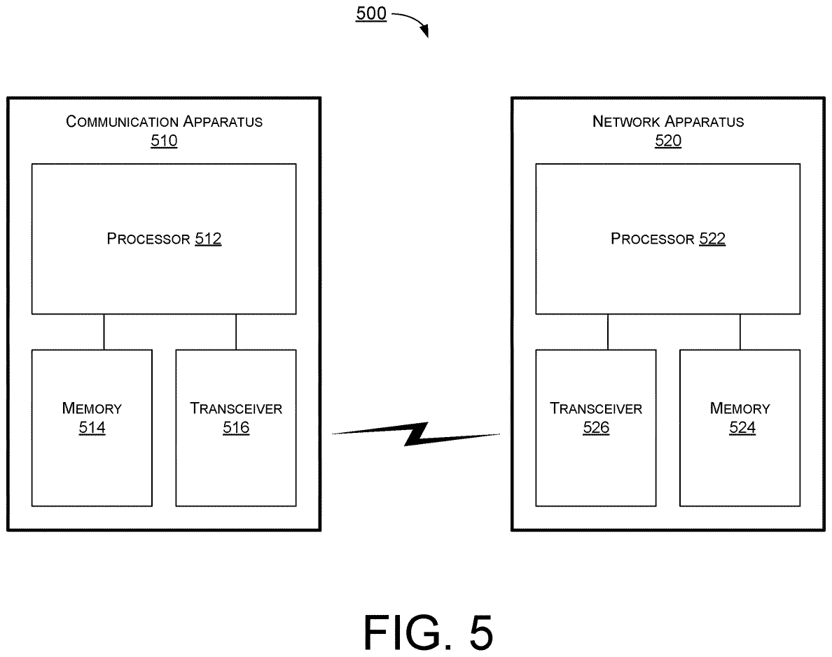

FIG. 5 illustrates an example communication system 500 having at least an example communication apparatus 510 and an example network apparatus 520 in accordance with an implementation of the present disclosure. Each of communication apparatus 510 and network apparatus 520 may perform various functions to implement schemes, techniques, processes and methods described herein pertaining to beam management, including the various schemes described above with respect to various proposed designs, concepts, schemes and methods described above and with respect to user equipment and network apparatus in mobile communications, including scenarios/schemes described above as well as process 600 and process 700 described below.

Communication apparatus 510 may be a part of an electronic apparatus, which may be a UE such as a portable or mobile apparatus, a wearable apparatus, a wireless communication apparatus or a computing apparatus. For instance, communication apparatus 510 may be implemented in a smartphone, a smartwatch, a personal digital assistant, a digital camera, or a computing equipment such as a tablet computer, a laptop computer or a notebook computer. Communication apparatus 510 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 510 may be implemented in a smart thermostat, a smart fridge, a smart door lock, a wireless speaker or a home control center. Alternatively, communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 510 may include at least some of those components shown in FIG. 5 such as a processor 512, for example. Communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

Network apparatus 520 may be a part of a network apparatus, which may be a network node such as a satellite, a base station, a small cell, a router or a gateway. For instance, network apparatus 520 may be implemented in an eNodeB in an LTE network, in a gNB in a 5G/NR, IoT, NB-IoT or IIoT network or in a satellite or base station in a 6G network. Alternatively, network apparatus 520 may be implemented in the form of one or more IC chips such as, for example and without limitation, one or more single-core processors, one or more multi-core processors, or one or more RISC or CISC processors. Network apparatus 520 may include at least some of those components shown in FIG. 5 such as a processor 522, for example. Network apparatus 520 may further include one or more other components not pertinent to the proposed scheme of the present disclosure (e.g., internal power supply, display device and/or user interface device), and, thus, such component(s) of network apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including autonomous reliability enhancements in a device (e.g., as represented by communication apparatus 510) and a network (e.g., as represented by network apparatus 520) in accordance with various implementations of the present disclosure.

In some implementations, communication apparatus 510 may also include a transceiver 516 coupled to processor 512 and capable of wirelessly transmitting and receiving data. In some implementations, communication apparatus 510 may further include a memory 514 coupled to processor 512 and capable of being accessed by processor 512 and storing data therein. In some implementations, network apparatus 520 may also include a transceiver 526 coupled to processor 522 and capable of wirelessly transmitting and receiving data. In some implementations, network apparatus 520 may further include a memory 524 coupled to processor 522 and capable of being accessed by processor 522 and storing data therein. Accordingly, communication apparatus 510 and network apparatus 520 may wirelessly communicate with each other via transceiver 516 and transceiver 526, respectively. To aid better understanding, the following description of the operations, functionalities and capabilities of each of communication apparatus 510 and network apparatus 520 is provided in the context of a mobile communication environment in which communication apparatus 510 is implemented in or as a communication apparatus or a UE and network apparatus 520 is implemented in or as a network node of a communication network.

In some implementations, processor 512 may receive, via transceiver 516, at least one reference signal from network apparatus 520. Processor 512 may transmit, via transceiver 516, a beam report to network apparatus 520, wherein the beam report may indicate at least one beam which has been synchronized by communication apparatus 510.

In some implementations, the beam report may further indicate at least one beam which has not been synchronized by communication apparatus 510.

In some implementations, the beam report may comprise at least one indicator indicating that the at least one beam has been synchronized by communication apparatus 510 or the at least one beam has not been synchronized by communication apparatus 510.

In some implementations, the at least one beam in the beam report may be indicated by one reference signal index or one TCI state index.

In some implementations, an association between a reference signal corresponding to the reference signal index and a TCI state corresponding to the TCI state index may be determined according to a QCL configuration in the TCI state or an RRC configuration.

In some implementations, the beam which has been synchronized by communication apparatus 510 may be applicable for downlink reception after the beam report is sent by communication apparatus 510.

In some implementations, the beam which has been not synchronized by communication apparatus 510 may be applicable for downlink reception after a reception of a reference signal associated with the beam. The reception of the reference signal associated with the beam may be after the beam report.

In some implementations, processor 512 may apply a beam activation command from network apparatus 520, wherein the beam activation command indicates at least one beam to be activated.

In some implementations, in an event that the beam indicated in the beam activation command is the beam in the beam report which has been synchronized by communication apparatus 510, the beam indicated in the beam activation command may be applicable for downlink reception after the beam activation command is applied.

In some implementations, in an event that the beam indicated in the beam activation command is the beam in the beam report which has been not synchronized by communication apparatus 510, the beam may be applicable for downlink reception after a reception of a reference signal associated with the beam indicated in the beam activation command. The reception of the reference signal associated with the beam indicated in the beam activation command is after the beam activation command.

In some implementations, processor 522 may transmit, via transceiver 526, at least one reference signal to communication apparatus 510. Processor 522 may receive, via transceiver 526, a beam report from communication apparatus 510, wherein the beam report indicates at least one beam which has been synchronized by communication apparatus 510.

In some implementations, the beam report further indicates at least one beam which has not been synchronized by communication apparatus 510, or wherein the beam report comprises at least one indicator indicating that the at least one beam has been synchronized by communication apparatus 510 or the at least one beam has not been synchronized by communication apparatus 510.

In some implementations, processor 522 may transmit, via transceiver 526, a beam activation command to the UE, wherein the beam activation command indicates at least one beam to be activated.

### Illustrative Processes

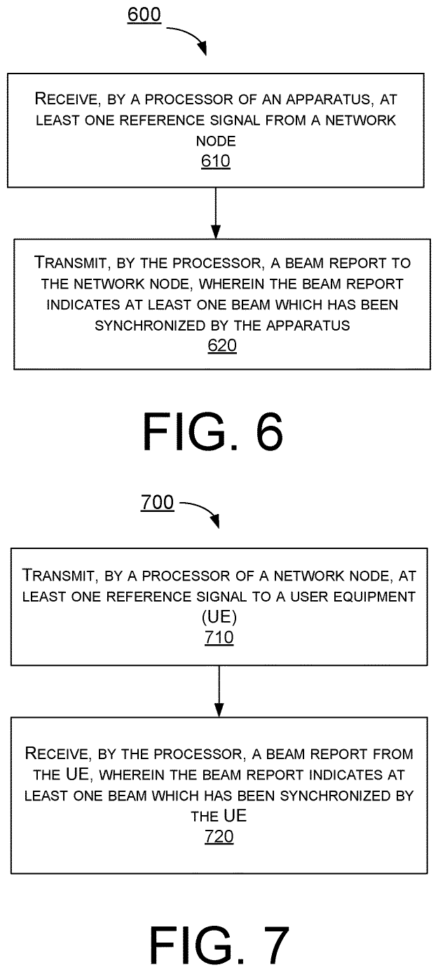

FIG. 6 illustrates an example process 600 in accordance with an implementation of the present disclosure. Process 600 may be an example implementation of above scenarios/schemes, whether partially or completely, with respect to beam management with the present disclosure. Process 600 may represent an aspect of implementation of features of communication apparatus 510. Process 600 may include one or more operations, actions, or functions as illustrated by one or more of blocks 610 and 620. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by communication apparatus 510 or any suitable UE or machine type devices. Solely for illustrative purposes and without limitation, process 600 is described below in the context of communication apparatus 510. Process 600 may begin at block 610.

At 610, process 600 may involve processor 512 of communication apparatus 510 receiving, via transceiver 516 of communication apparatus 510, at least one reference signal from a network node. Process 600 may proceed from 610 to 620.

At 620, process 600 may involve processor 512 transmitting, via transceiver 516, a beam report to the network node, wherein the beam report indicates at least one beam which has been synchronized by communication apparatus 510.

In some implementations, process 600 may involve processor 512 applying a beam activation command from the network node, wherein the beam activation command indicates at least one beam to be activated.

FIG. 7 illustrates an example process 700 in accordance with another implementation of the present disclosure. Process 700 may be an example implementation of above scenarios/schemes, whether partially or completely, with respect to beam management with the present disclosure. Process 700 may represent an aspect of implementation of features of network apparatus 520. Process 700 may include one or more operations, actions, or functions as illustrated by one or more of blocks 710 and 720. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by network apparatus 520 or any base stations or network nodes. Solely for illustrative purposes and without limitation, process 700 is described below in the context of network apparatus 520. Process 700 may begin at block 710.

At 710, process 700 may involve processor 522 of network apparatus 520 transmitting, via transceiver 526 of network apparatus 520, at least one reference signal to a UE. Process 700 may proceed from 710 to 720.

At 720, process 700 may involve processor 522 receiving, via transceiver 526, a beam report from the UE, wherein the beam report indicates at least one beam which has been synchronized by the UE.

In some implementations, process 700 may involve processor 522 transmitting, via transceiver 526, a beam activation command to the UE, wherein the beam activation command indicates at least one beam to be activated.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, at least one reference signal from a network node; and
transmitting, by the processor, a beam report to the network node, wherein the beam report indicates at least one beam which has been synchronized by the apparatus.

2. The method of claim 1, wherein the beam report further indicates at least one beam which has not been synchronized by the apparatus.

3. The method of claim 2, wherein the beam report comprises at least one indicator indicating that the at least one beam has been synchronized by the apparatus or the at least one beam has not been synchronized by the apparatus.

4. The method of claim 1, wherein the at least one beam in the beam report is indicated by one reference signal index or one transmission configuration indicator (TCI) state index.

5. The method of claim 4, wherein an association between a reference signal corresponding to the reference signal index and a TCI state corresponding to the TCI state index is determined according to a quasi-co-location (QCL) configuration in the TCI state or a radio resource control (RRC) configuration.

6. The method of claim 1, wherein the beam which has been synchronized by the apparatus is applicable for downlink reception after the beam report is sent by the apparatus.

7. The method of claim 2, wherein the beam which has been not synchronized by the apparatus is applicable for downlink reception after a reception of a reference signal associated with the beam.

8. The method of claim 7, wherein the reception of the reference signal associated with the beam is after the beam report.

9. The method of claim 1, further comprising:
applying, by the processor, a beam activation command from the network node, wherein the beam activation command indicates at least one beam to be activated.

10. The method of claim 9, wherein in an event that the beam indicated in the beam activation command is the beam in the beam report which has been synchronized by the apparatus, the beam indicated in the beam activation command is applicable for downlink reception after the beam activation command is applied.

11. The method of claim 9, wherein in an event that the beam indicated in the beam activation command is the beam in the beam report which has been not synchronized by the apparatus, the beam is applicable for downlink reception after a reception of a reference signal associated with the beam indicated in the beam activation command.

12. The method of claim 11, wherein the reception of the reference signal associated with the beam indicated in the beam activation command is after the beam activation command.

13. An apparatus, comprising:
a transceiver which, during operation, wirelessly communicates with at least one network node; and
a processor communicatively coupled to the transceiver such that, during operation, the processor performs operations comprising:
receiving, via the transceiver, at least one reference signal from the network node; and
transmitting, via the transceiver, a beam report to the network node, wherein the beam report indicates at least one beam which has been synchronized by the apparatus.

14. The apparatus of claim 13, wherein the beam report further indicates at least one beam which has not been synchronized by the apparatus.

15. The apparatus of claim 14, wherein the beam report comprises at least one indicator indicating that the at least one beam has been synchronized by the apparatus or the at least one beam has not been synchronized by the apparatus.

16. The apparatus of claim 13, wherein the at least one beam in the beam report is indicated by one reference signal index or one transmission configuration indicator (TCI) state index.

17. The apparatus of claim 13, wherein the beam which has been synchronized by the apparatus is applicable for downlink reception after the beam report is sent by the apparatus.

18. The apparatus of claim 14, wherein the beam which has been not synchronized by the apparatus is applicable for downlink reception after a reception of a reference signal associated with the beam, and wherein the reception of the reference signal associated with the beam is after the beam report.

19. The apparatus of claim 13, wherein the processor is further configured to perform operations comprising:
applying, by the processor, a beam activation command from the network node, wherein the beam activation command indicates at least one beam to be activated.

20. The apparatus of claim 19, wherein in an event that the beam indicated in the beam activation command is the beam in the beam report which has been synchronized by the apparatus, the beam indicated in the beam activation command is applicable for downlink reception after the beam activation command is applied, wherein in an event that the beam indicated in the beam activation command is the beam in the beam report which has been not synchronized by the apparatus, the beam is applicable for downlink reception after a reception of a reference signal associated with the beam indicated in the beam activation command, and wherein the reception of the reference signal associated with the beam indicated in the beam activation command is after the beam activation command.

21. A method, comprising:
transmitting, by a processor of a network node, at least one reference signal to a user equipment (UE); and
receiving, by the processor, a beam report from the UE, wherein the beam report indicates at least one beam has been synchronized by the UE.

22. The method of claim 21, wherein the beam report further indicates at least one beam which has not been synchronized by the apparatus, or wherein the beam report comprises at least one indicator indicating that the at least one beam has been synchronized by the apparatus or the at least one beam has not been synchronized by the apparatus.

23. The method of claim 21, further comprising:
transmitting, by the processor, a beam activation command to the UE, wherein the beam activation command indicates at least one beam to be activated.
